(19) United States
(12) Patent Application Publication
(10) Pub. No.: US 2025/0361031 A1
(43) Pub. Date: Nov. 27, 2025

(54) STRINGER HANDLING AND FORMING TOOL

(71) Applicants: The Boeing Company, Arlington, VA (US); University of Washington, Seattle, WA (US)

(72) Inventors: Anthony Dai-Ting Cheng, Seattle, WA (US); Shuonan Dong, Seattle, WA (US); Daniel James McMillan, Edmonds, WA (US); Silas Lawton Studley, Lake Forest Park, WA (US); Samuel F. Pedigo, Seattle, WA (US); Jonathan Young Ahn, Seattle, WA (US); Michael Hoyan Wan, Houston, TX (US); Yoshua Gombo, Seattle, WA (US); Anuj Tiwari, Seattle, WA (US); Xu Chen, Seattle, WA (US); Santosh Devasia, Seattle, WA (US); Ben Healey, Seattle, WA (US); Kennan Gaibel, Seattle, WA (US); James Guo, Seattle, WA (US); Peter Christopher Correa, Seattle, WA (US)

(21) Appl. No.: 18/671,766

(22) Filed: May 22, 2024

(51) Int. Cl. B64F 5/50; B29C 31/00; B29L 31/30; B64C 3/18

(52) U.S. Cl. CPC B64F 5/50; B29C 31/008; B29L 2031/3085; B64C 3/182

(57) ABSTRACT

A method and a handling system for imparting a desired longitudinal conformation into a longitudinal component are presented. The handling system comprises a rigid frame and a plurality of handling headers movably connected to the rigid frame. The plurality of handling headers is configured to grip a longitudinal component, lift the longitudinal component, and cooperatively move to impart the desired longitudinal conformation into the longitudinal component.

### BACKGROUND INFORMATION

### 1. Field

The present disclosure relates generally to composite manufacturing and more specifically to handling and forming of composite stringers.

### 2. Background

Large composite structures, for example aircraft wings, can include a composite skin and composite stringers for stiffening the skin. Some composite stringers are shaped according to the section of an aircraft skin along which the stringer is to be attached, to have complex geometry including a cross sectional shape, contour, and twist. Existing composite fabrication processes utilize a ply-by-ply lamination and forming approach.

After fabrication, uncured or partially cured stringers are typically handled either manually on carts or by overhead cranes, which is often time consuming and expensive. The fabrication process of a composite stiffening member often applies general contour geometries to the stringer, but often does not apply twist or skew.

Therefore, it would be desirable to have a method and apparatus that takes into account at least some of the issues discussed above, as well as other possible issues. For example, it would be desirable to provide a method of providing a twist or skew into a composite stringer.

### SUMMARY

An embodiment of the present disclosure provides a handling system for imparting a desired longitudinal conformation into a longitudinal component. The handling system comprises a rigid frame and a plurality of handling headers movably connected to the rigid frame. The plurality of handling headers is configured to grip a longitudinal component, lift the longitudinal component, and cooperatively move to impart the desired longitudinal conformation into the longitudinal component.

Another embodiment of the present disclosure provides a handling system for imparting a desired longitudinal conformation into a longitudinal component. The handling system comprises a rigid frame comprising a plurality of cross-beams and a plurality of handling headers movably connected to the plurality of cross-beams. The plurality of handling headers is configured to maintain an axis of rotation at a centerline of a base of the longitudinal component. Each handling header of the plurality of handling headers comprises a base configured to traverse a cross-beam of the plurality of cross-beams of the rigid frame, a body movably connected to the base by a lift actuator, a curved rail mounted on the body, and a gripper movably connected to the curved rail and configured to contact and lift the longitudinal component.

Yet another embodiment of the present disclosure provides a method of imparting a desired longitudinal conformation into a longitudinal component. The longitudinal component is gripped with a plurality of handling headers of a handling system. The longitudinal component is lifted using the handling system. At least one handling header of the plurality of handling headers is moved relative to another of the plurality of handling headers to impart the desired longitudinal conformation into the longitudinal component.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a handling system in accordance with an illustrative embodiment;

FIG. 4 is an illustration of a handling header of a handling system in a first position in accordance with an illustrative embodiment;

FIG. 5 is an illustration of a handling header of a handling system in a second position in accordance with an illustrative embodiment;

FIG. 6 is an illustration of a handling header of a handling system in a third position in accordance with an illustrative embodiment;

FIG. 7 is an illustration of a handling header in a handling system in the third position in accordance with an illustrative embodiment;

FIG. 8 is an illustration of an isometric view of a handling header in a third position in accordance with an illustrative embodiment;

FIG. 9 is an illustration of an isometric exploded view of a handling header in accordance with an illustrative embodiment;

FIG. 10 is an illustration of an isometric bottom view of a handling system in accordance with an illustrative embodiment;

FIG. 11 is an illustration of a front view of handling headers gripping stringers of different thicknesses in accordance with an illustrative embodiment;

FIGS. 12A and 12B are a flowchart of a method of imparting a desired longitudinal conformation into a longitudinal component in accordance with an illustrative embodiment;

FIG. 13 is an illustration of an aircraft manufacturing and service method in a form of a block diagram in accordance with an illustrative embodiment; and

FIG. 14 is an illustration of an aircraft in a form of a block diagram in which an illustrative embodiment may be implemented.

### DETAILED DESCRIPTION

The illustrative examples recognize and take into account several considerations. The illustrative embodiments recognize and take into account that currently to apply a desired longitudinal conformation including a twist to a contoured stringer, the contoured but not fully formed stringer can be draped on a mating skin surface. In an uncured or partially cured state, a stringer is susceptible to undesired wrinkling and deformation. Manually applying a twist to the stringer in this state can generate wrinkles or other undesirable inconsistencies in the stringer.

The illustrative examples recognize and take into account that in another manual process, an overhead handling tool cranes the stringer after general contouring is applied and operators can manually adjust sections of the stringer sequentially on a handling tool to desired angles, forcing the stringer into twist. The illustrative examples recognize and take into account that this process can take several hours and often requires adjustment of each location of a stringer multiple times.

The illustrative examples recognize and take into account that it would be desirable to be able to batch each process step for a longitudinal component. For example, it would be desirable to laminate a full stack of material, form the full stack into shape and contour, then apply a desired longitudinal conformation to the product in its uncured or partially cured state, and utilize automated handling to move the longitudinal component with the desired longitudinal conformation onto wing skin having a correspondingly configured surface geometry, or a tool, or another surface. In some illustrative examples, the desired longitudinal conformation can include a twist.

The illustrative examples combine automated stringer handling with the ability to form the stringer in twist, by applying simultaneous control of many handling points down the length of the stringer to rotate locally about the contoured centerline on the stringer base. The illustrative examples present an automated stringer handling system that not only picks and places a stringer, but can also apply twist and skew to the stringer during this process, allowing the stringer geometry to fully match that of a target mating surface, such as a wing skin.

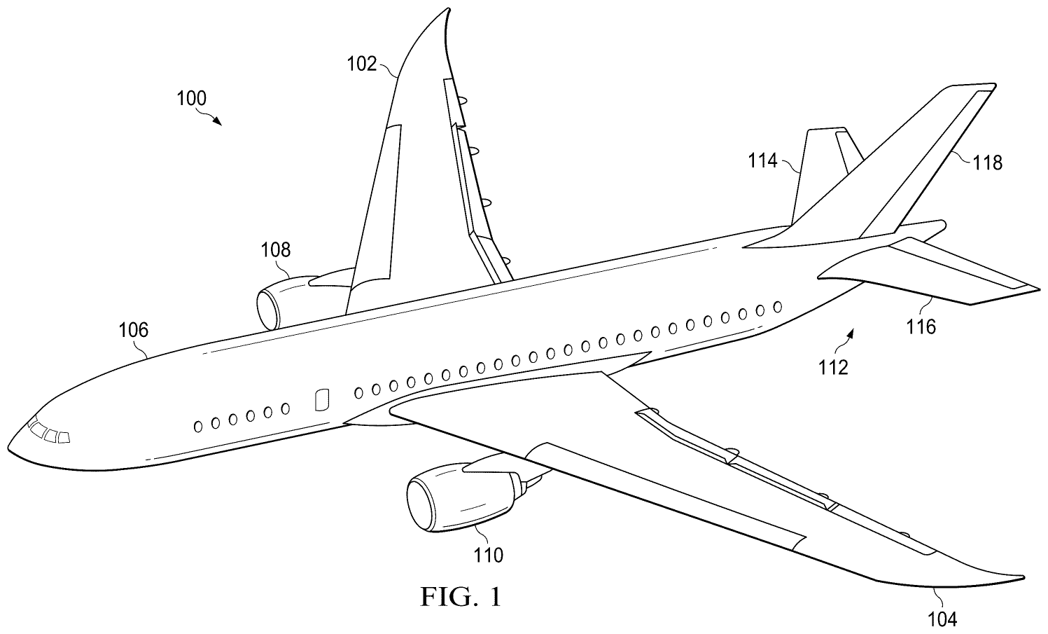

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite stringers formed using the methods of the illustrative examples. Composite stringers of aircraft 100 can be moved into a desired longitudinal conformation using the handling system of the illustrative examples. In some illustrative examples, composite stringers of aircraft 100 can be twisted using the handling system of the illustrative examples. A composite stringer of at least one of wing 102, wing 104, or body 106 can be moved into a desired longitudinal conformation using the methods and handling system of the illustrative examples.

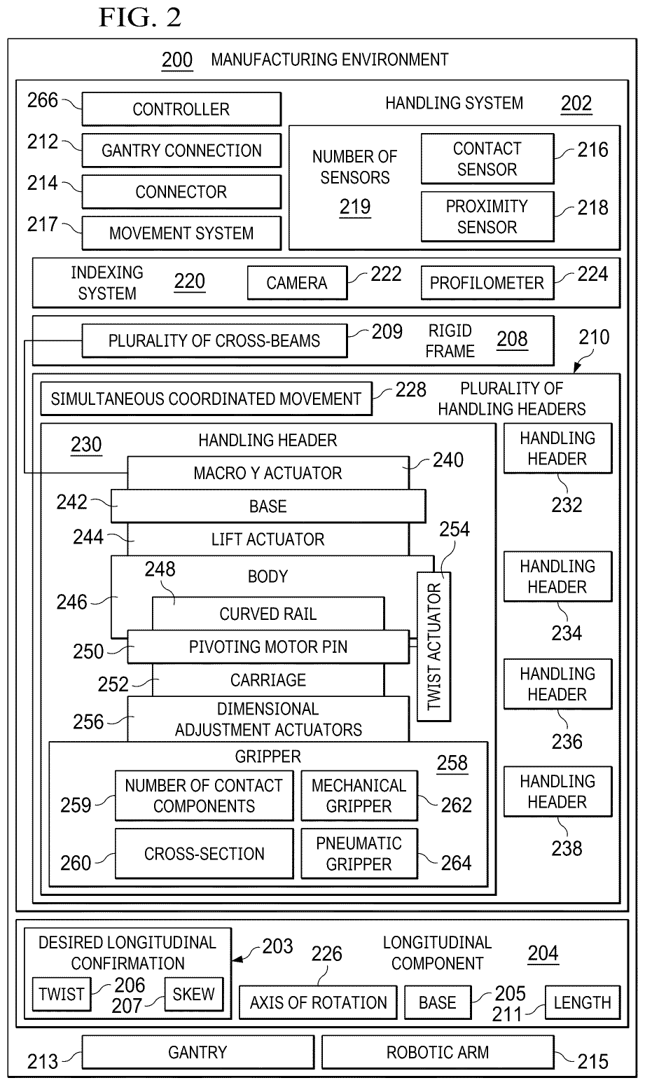

Turning now to FIG. 2, an illustration of a block diagram of a manufacturing environment is depicted in accordance with an illustrative embodiment. Handling system 202 in manufacturing environment 200 is configured to impart desired longitudinal conformation 203 into longitudinal component 204.

Longitudinal component 204 can take any desirable form and have any desirable cross-section. In some illustrative examples, longitudinal component 204 can be a composite stringer or other form of composite stiffener.

Handling system 202 is configured to manipulate longitudinal component 204 into desired longitudinal conformation 203. Desired longitudinal conformation 203 of longitudinal component 204 may be dictated by the conformation of a section of aircraft 100 or other platform along which longitudinal component 204 is to be installed. In some examples, the installation location of longitudinal component 204 within aircraft 100 or another platform is non-planar, curved, twisted, lofted, and/or contoured. Thus, desired longitudinal conformation 203 may be correspondingly non-linear, twisted, skewed, and/or lofted. More specifically, in desired longitudinal conformation 203, the cross-sectional shape of longitudinal component 204 may be at least substantially uniform along length 211, but individual cross-sections of longitudinal component 204 may be one or more of, twisted, skewed, and/or lofted relative to one another. Handling system 202 may be configured to manipulate longitudinal component 204 into desired longitudinal conformation 203 and subsequently place longitudinal component 204 on an installation location of longitudinal component 204 with longitudinal component 204 conformed in desired longitudinal conformation 203 by handling system 202.

Handling system 202 comprises rigid frame 208, and plurality of handling headers 210 movably connected to rigid frame 208. Plurality of handling headers 210 is configured to grip longitudinal component 204, lift longitudinal component 204, and cooperatively move to impart desired longitudinal conformation 203 to longitudinal component 204. Desired longitudinal conformation 203 can include at least one of twist 206 or skew 207.

Handling system 202 is configured to control the position and orientation of plurality of handling headers 210 relative to, and/or independently of, one another to arrange plurality of handling headers 210 along a path that corresponds to a desired longitudinal shape of longitudinal component 204. Accordingly, when longitudinal component 204 is gripped by handling system 202, handling system 202 is configured to manipulate longitudinal component 204 into the desired longitudinal conformation 203 by controlling the positions and orientations of plurality of handling headers 210 relative to one another.

In some illustrative examples, plurality of handling headers 210 can simultaneously begin forming longitudinal component 204, and simultaneously stop movement to impart desired longitudinal conformation 203 into longitudinal component 204. In some illustrative examples, handling system 202 is configured to perform simultaneous coordinated movement 228 of plurality of handling headers 210.

Handling system 202 can provide simultaneous twist velocity control across plurality of handling headers 210 to have all handling headers of plurality of handling headers 210 start and end a twisting process simultaneously. Controls for simultaneous coordinated movement 228 of plurality of handling headers 210 provides for twisting to start and end at the same time for each handling header of plurality of handling headers 210. When utilized, simultaneous coordinated movement 228 allows a more even spread of stresses throughout longitudinal component 204 than sequential application of twist at discrete locations. When imparting a desired longitudinal conformation 203, even stress distribution can help avoid wrinkling longitudinal component 204.

In this illustrative example, handling system 202 comprises controller 266 that is configured and/or programmed to control operation of at least a portion of handling system 202. As examples, controller 266 may be in communication with one or more components or systems of handling system 202 and be configured to send one or more control signals to the one or more components of handling system 202 to control the operation thereof. In some examples, controller is in communication with one or more sensors comprised in handling system 202 and is configured to issue command signals to the one or more components based on the sensor signals received from the one or more sensors. In some examples, controller 266 is in communication with and configured to control actuators of each handling header, such as to actuate each macro Y actuator, each lift actuator, each twist actuator, and each dimensional adjustment actuator. In some examples, controller 266 is configured to control each handling header of plurality of handling headers 210 to control the position and orientation of the respective handling headers, as discussed herein.

Controller 266 may include and/or be any suitable structure, device, and/or devices that may be adapted, configured, designed, constructed, and/or programmed to perform the functions discussed herein. As examples, controller 266 may include one or more of an electronic controller, a dedicated controller, a special-purpose controller, a personal computer, a special-purpose computer, a display device, a logic device, a processing unit, a memory device, and/or a memory device having computer-readable storage media.

In some illustrative examples, controller 266 can be is located in a computer system and can be implemented in software, hardware, firmware, or a combination thereof. When software is used, the operations performed by controller 266 can be implemented in program instructions configured to run on hardware, such as a processor unit. When firmware is used, the operations performed by controller 266 can be implemented in program instructions and data stored in persistent memory to run on a processor unit. When hardware is employed, the hardware can include circuits that operate to perform the operations in controller 266.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices.

A computer system is a physical hardware system and includes one or more data processing systems. When more than one data processing system is present in the computer system, those data processing systems are in communication with each other using a communications medium. The communications medium can be a network. The data processing systems can be selected from at least one of a computer, a server computer, a tablet computer, or some other suitable data processing system.

A computer system can include a number of processor units that are capable of executing program instructions implementing processes for controller 266 in the illustrative examples. In other words, the program instructions are computer-readable program instructions.

As depicted, plurality of handling headers 210 comprises five handling headers: handling header 230, handling header 232, handling header 234, handling header 236, and handling header 238. In other non-depicted illustrative examples greater than five handling headers can be present. In other non-depicted illustrative examples, fewer than five handling headers can be present. In FIG. 2, components of handling header 230 are depicted for discussion. Handling header 230 is representative of each handling header of plurality of handling headers 210.

When a longitudinal component 204 is held aloft by the handling headers 210, movement of any handling header of plurality of handling headers 210 relative to at least one other can impart a change to the longitudinal conformation of longitudinal component 204. In some illustrative examples, at least one handling header of plurality of handling headers 210 does not move while imparting desired longitudinal conformation 203 into longitudinal component 204. In some illustrative examples, plurality of handling headers 210 are moved in coordination but each of plurality of handling headers 210 has its own independent length of time for movement. In some illustrative examples, at least one of plurality of handling headers 210 is moved but is not moved for the whole time of imparting desired longitudinal conformation 203 into longitudinal component 204.

Plurality of handling headers 210 is configured to move along plurality of cross-beams 209. Plurality of handling headers 210 can travel along plurality of cross-beams 209 using a plurality of macro Y actuators, including macro Y actuator 240 of handling header 230. Actuation in skew (y-axis) achieves a stringer natural path. Movement of handling header 230 along a respective cross-beam of plurality of cross-beams 209 provides a natural path for longitudinal component 204.

As depicted, handling header 230 comprises base 242 configured to traverse a cross-beam of plurality of cross-beams 209 of rigid frame 208; body 246 movably connected to base 242 by lift actuator 244; curved rail 248 mounted on body 246; and gripper 258 movably connected to curved rail 248 and configured to contact and lift longitudinal component 204. In this illustrative example, handling header 230 further comprises carriage 252 movably connected to curved rail 248. In this illustrative example, gripper 258 is connected to carriage 252 by dimensional adjustment actuator 256.

Lift actuator 244 provides actuation in z-axis to match a large scale stringer contour at each handling header. Lift actuator 244 can generate a curvature or contour or maintain a curvature or curvature along length 211 of longitudinal component 204. Lift actuator 244 can be used to lower handling header 230 into contact with longitudinal component 204. In some illustrative examples, lift actuator 244 is used to lower gripper 258 into contact with longitudinal component 204. In some illustrative examples, lift actuator 244 is used to lift longitudinal component 204. In some illustrative examples, lift actuator 244 is used to place longitudinal component 204 onto a tool or a composite skin after placing twist 206 into longitudinal component 204.

In other illustrative examples, rigid frame 208 is moved by one of gantry 213 or robotic arm 215 to lift longitudinal component 204. In some illustrative examples, movement of rigid frame 208 can be used to move plurality of handling headers 210 relative to longitudinal component 204.

Dimensional adjustment actuator 256 move gripper 258 to maintain a desired location for axis of rotation 226. Micro compliance in z-axis provided by dimensional adjustment actuator 256 provides local matching of a material gage thickness of longitudinal component 204.

After placing gripper 258 in contact with longitudinal component 204, gripper 258 grips longitudinal component 204. Gripper 258 takes the form of one of mechanical gripper 262 or pneumatic gripper 264. In some illustrative examples, gripper 258 grips longitudinal component 204 mechanically. In some illustrative examples, gripper 258 grips longitudinal component 204 pneumatically. Cross-section 260 of gripper 258 is configured to grip longitudinal component 204 based on the cross-section of longitudinal component 204. In some illustrative examples, longitudinal component 204 has a cross-sectional shape selected from at least one of a T shaped cross-section, L shaped cross-section, C shaped cross-section, or any other desired cross-section.

Gripper 258 comprises number of contact components 259. A quantity of number of contact components 259 is selected based on the cross-sectional shape of longitudinal component 204. Number of contact components 259 can include one contact component, two contact components, or more. In some illustrative examples, number of contact components 259 comprises four contact components.

Each handling header is configured to maintain axis of rotation 226 at a centerline of base 205 of longitudinal component 204. Movement of gripper 258 relative to curved rail 248 is configured to maintain axis of rotation 226 at a centerline of base 205 of longitudinal component 204. Vertical positioning of gripper 258 relative to carriage 252 is configured to maintain axis of rotation 226 at a centerline of base 205 of longitudinal component 204.

Handling header 230 with pivoting motor pin 250 slides on curved rail 248 for twist around contoured axis of rotation 226 at centerline of base 205 of longitudinal component 204. Pivoting motor pin 250 allows twist actuator 254 to drive carriage 252 around curved rail 248.

In some illustrative examples, rigid frame 208 is movable within manufacturing environment 200. In some illustrative examples, movement system 217 is connected to rigid frame 208 and configured to allow movement of rigid frame 208 across a manufacturing floor. In some illustrative examples, movement system 217 comprises at least one of a track, wheels, bearings, or other desirable movement components.

In some illustrative examples, handling system 202 comprises gantry connection 212 configured to attach handling system 202 to gantry 213. In some illustrative examples, handling system 202 comprises connector 214 configured to attach handling system 202 to robotic arm 215.

In some illustrative examples, handling system 202 comprises number of sensors 219 configured to determine a distance of plurality of handling headers 210 from longitudinal component 204. Number of sensors 219 is selected from contact sensor 216 or proximity sensor 218. Contact sensor 216 can be used to detect contact of gripper 258 with longitudinal component 204.

In some illustrative examples, handling system 202 comprises indexing system 220 comprising at least one of camera 222 or profilometer 224 and configured to provide indexing data for plurality of handling headers 210 relative to longitudinal component 204. Indexing can be performed using camera 222, profilometer 224, or other metrology. Indexing can be performed using camera 222 or profilometer 224 to detect a corner and edge of stringer. Data is fed back to header controllers to index gripping locations.

Simultaneous twist velocity control across all handling headers can be used to ensure all handling headers start and end twisting process simultaneously, for even stress distribution in longitudinal component 204. Even stress distribution can reduce wrinkling in longitudinal component 204.

In some examples, applying twist, skew, and/or loft to a hat stringer can result in compression being applied to certain regions of longitudinal component 204 and tension being applied to other regions of longitudinal component 204 that may be opposed to the regions of longitudinal component 204 that are under compression. In some illustrative examples, handling system 202 is configured to apply tension to longitudinal component 204 along length 211. In some illustrative examples, handling system 202 is configured to apply tension to longitudinal component 204 along length 211 to reduce compression in portions of longitudinal component 204 and/or to prevent wrinkling of longitudinal component 204. In particular, in some examples, handling system 202 is configured to maintain tension in longitudinal component 204 along length 211 as handling system 202 applies twist, skew, and/or loft to longitudinal component 204. In some examples, handling system 202 is configured to relieve compression in longitudinal component 204 and prevent wrinkling in longitudinal component 204 by applying this tension evenly across the thickness of longitudinal component 204.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although not depicted in FIG. 2, cart fixtures can be used to connect carriage 252 to curved rail 248. As another illustrative example, although not depicted in FIG. 2, longitudinal component 204 can have a curvature. Additionally, longitudinal component 204 can have at least one of a varying cross-section, a varying thickness, or a varying height.

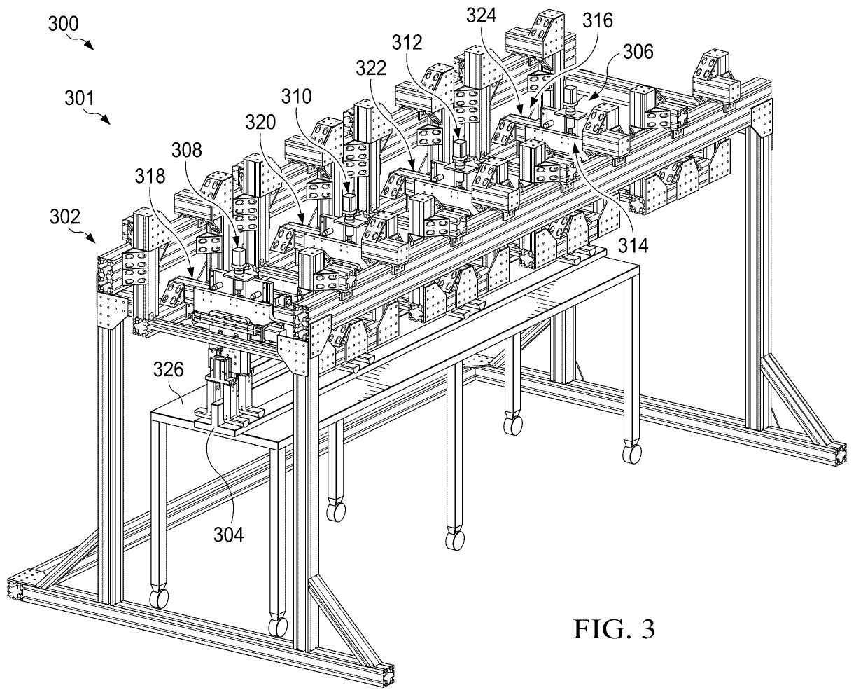

Turning now to FIG. 3, an illustration of a handling system is depicted in accordance with an illustrative embodiment. In view 300, handling system 301 is positioned to lift and impart a desired longitudinal conformation into longitudinal component 304. Handling system 301 is a physical implementation of handling system 202 of FIG. 2.

Handling system 301 comprises rigid frame 302 and plurality of handling headers 306. In this illustrative example, plurality of handling headers 306 comprises four handling headers. In other illustrative examples, handling system 301 can include more than four handling headers.

In this illustrative example, plurality of handling headers 306 comprises handling header 308, handling header 310, handling header 312, and handling header 314. Each of plurality of handling headers 306 is movably connected to a cross beam of plurality of cross beams 316 of rigid frame 302. Movement of a handling header along a respective cross beam moves the handling header horizontally relative to longitudinal component 304. The horizontal movement of the handling header is perpendicular to a longitudinal axis of longitudinal component 304.

In this illustrative example, handling header 308 is movably connected to cross beam 318. In this illustrative example, handling header 310 is movably connected to cross beam 320. In this illustrative example, handling header 312 is movably connected to cross beam 322. In this illustrative example, handling header 314 is movably connected to cross beam 324.

As depicted, longitudinal component 304 rests on layup table 326. In this illustrative example, layup table 326 transports longitudinal component 304 to handling system 301. In some illustrative examples, during imparting the desired longitudinal conformation into longitudinal component 304, layup table 326 can be removed and a tool can be positioned beneath handling system 301 to receive longitudinal component 304 with the desired longitudinal conformation.

Although rigid frame 302 of handling system 301 is depicted as stationary, in other illustrative examples, a movement system can be connected to rigid frame 302. In some illustrative examples, a plurality of wheels, tracks, or other desirable movement system can be connected to rigid frame 302 to move handling system 301 within a manufacturing environment. In some non-depicted examples, handling system 301 can be connected to one of a gantry or a robotic arm to move handling system 301 within a manufacturing environment.

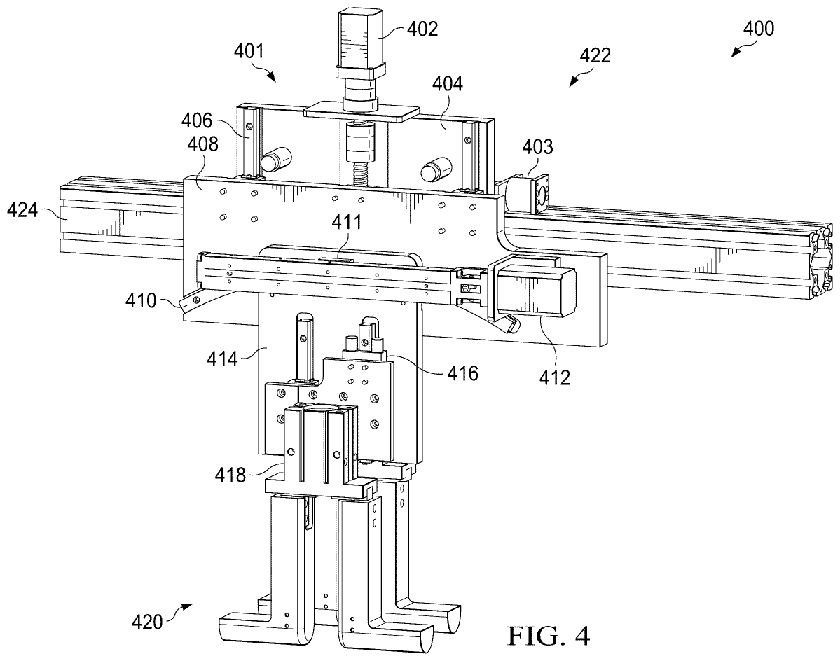

Turning now to FIG. 4, an illustration of a handling header of a handling system in a first position is depicted in accordance with an illustrative embodiment. Handling header 401 is depicted in neutral position 422 in view 400. Handling header 401 can be a physical implementation of one of plurality of handling headers 210 of FIG. 2. Handling header 401 in view 400 can be a physical implementation of one of plurality of handling headers 306 of FIG. 3.

Handling header 401 is configured to move along cross-beam 424. Cross-beam 424 is a portion of a handling system. Macro Y actuator 403 enables movement of base 404 of handling header 401 along cross-beam 424. Base 404 is configured to traverse cross-beam 424 of the plurality of cross-beams of a rigid frame (not depicted).

Body 408 is movably connected to base 404 by lift actuator 402. Lift actuator 402 moves body 408 relative to base 404 on tracks 406. Lift actuator 402 lowers body 408 relative to base 404 to place gripper 420 in contact with a longitudinal component. Lift actuator 402 lifts body 408 relative to base 404 to lift the longitudinal component when gripper 420 is gripping the longitudinal component.

Gripper 420 is movably connected to body 408. As used herein, a component can connected to a second component by being directly connected or indirectly connected. Gripper 420 is movably connected to body 408 through carriage 414. Carriage 414 is movably connected to body 408. Carriage 414 is movably connected to curved rail 410. Curved rail 410 is mounted on body 408.

Twist actuator 412 drives pivoting motor pin 411 along curved rail 410. Pivoting motor pin 411 connects carriage 414 to twist actuator 412. Twist actuator 412 drives movement of carriage 414 along curved rail 410. Movement of carriage 414 can impart at least one of twist or skew into a longitudinal component held by gripper 420.

In this illustrative example, handling header 401 further comprises dimensional adjustment actuator 416. Dimensional adjustment actuator 416 is configured to move gripper 420 relative to carriage 414. Movement of gripper 420 by dimensional adjustment actuator 416 can be used for small movements of gripper 420 for placing gripper 420 in contact with a longitudinal component. In some illustrative examples, movement of gripper 420 by dimensional adjustment actuator 416 can be used for small movements of gripper 420 for placing a twist or a skew into a longitudinal component.

In view 400, handling header 401 is in neutral position 422. In neutral position 422, gripper 420 is positioned such that gripper 420 can be placed into a longitudinal component to form the longitudinal component.

In this illustrative example, gripper 420 is a mechanical gripper. Gripper 420 has a cross-section configured to grip and lift a T-shaped composite stringer. In this illustrative example, gripper 420 has actuators 418 configured to open and close gripper 420 to grip and release a longitudinal component.

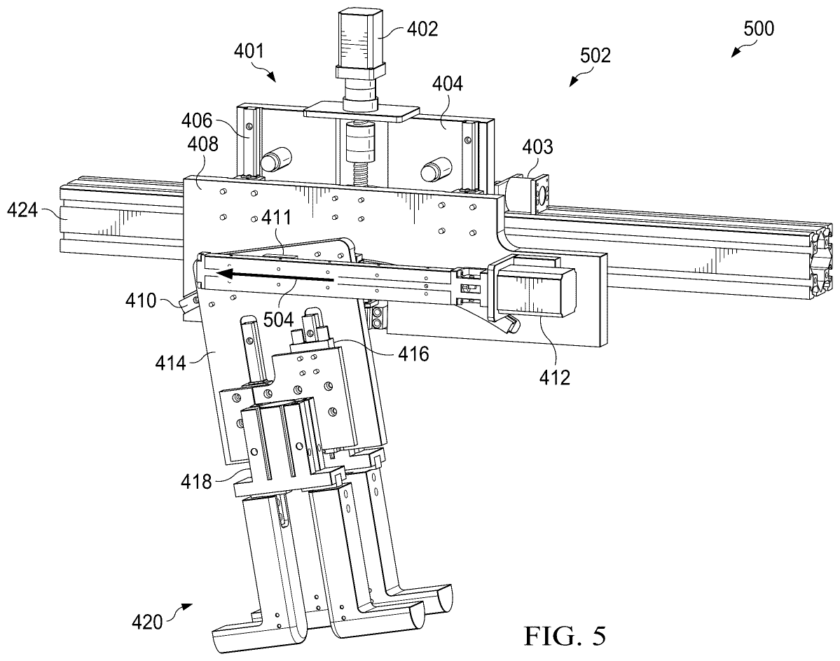

Turning now to FIG. 5, an illustration of a handling header of a handling system in a second position is depicted in accordance with an illustrative embodiment. View 500 is a view of handling header 401 in second position 502. In second position 502, carriage 414 has moved along curved rail 410. To place carriage 414 in second position 502, twist actuator 412 drives pivoting motor pin 411 in direction 504. By movement of carriage 414 along curved rail 410, an axis of rotation can be maintained at a base of a longitudinal component held by gripper 420.

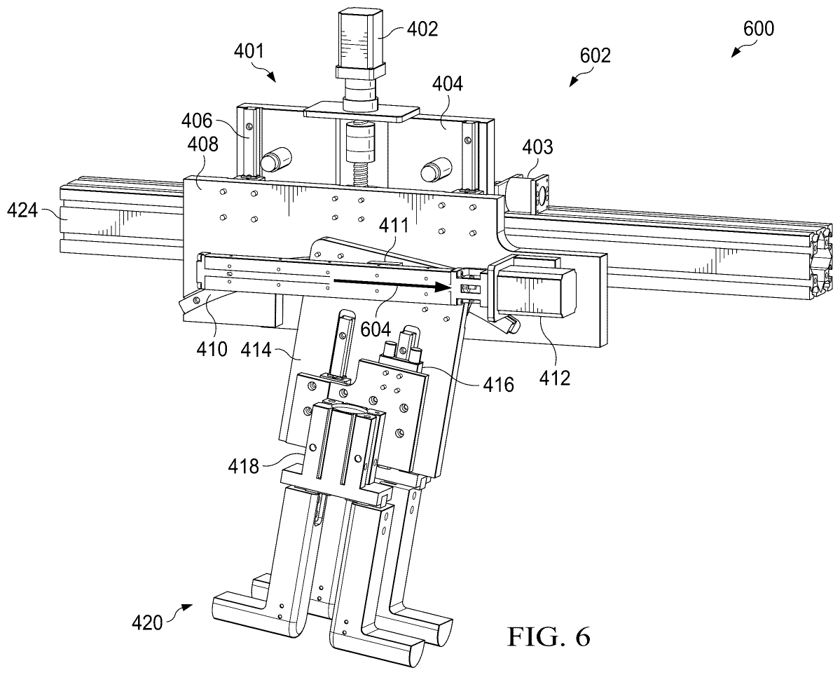

Turning now to FIG. 6, an illustration of a handling header of a handling system in a third position is depicted in accordance with an illustrative embodiment. View 600 is a view of handling header 401 in third position 602. In third position 602, carriage 414 has moved along curved rail 410. To place carriage 414 in third position 602, twist actuator 412 drives pivoting motor pin 411 in direction 604.

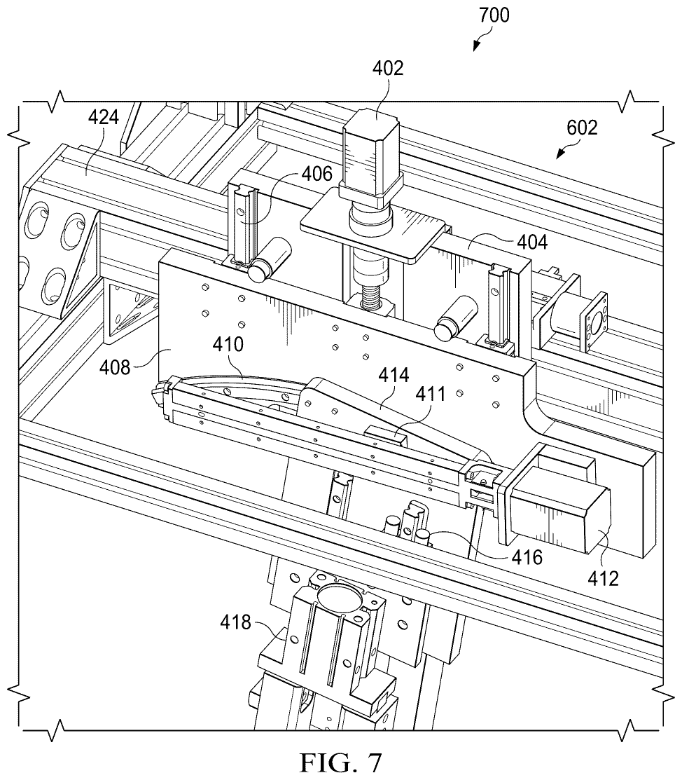

Turning now to FIG. 7, an illustration of a handling header in a handling system in the third position is depicted in accordance with an illustrative embodiment. View 700 is a top isometric view of handling header 401. In view 700, curved rail 410 and pivoting motor pin 411 are more visible.

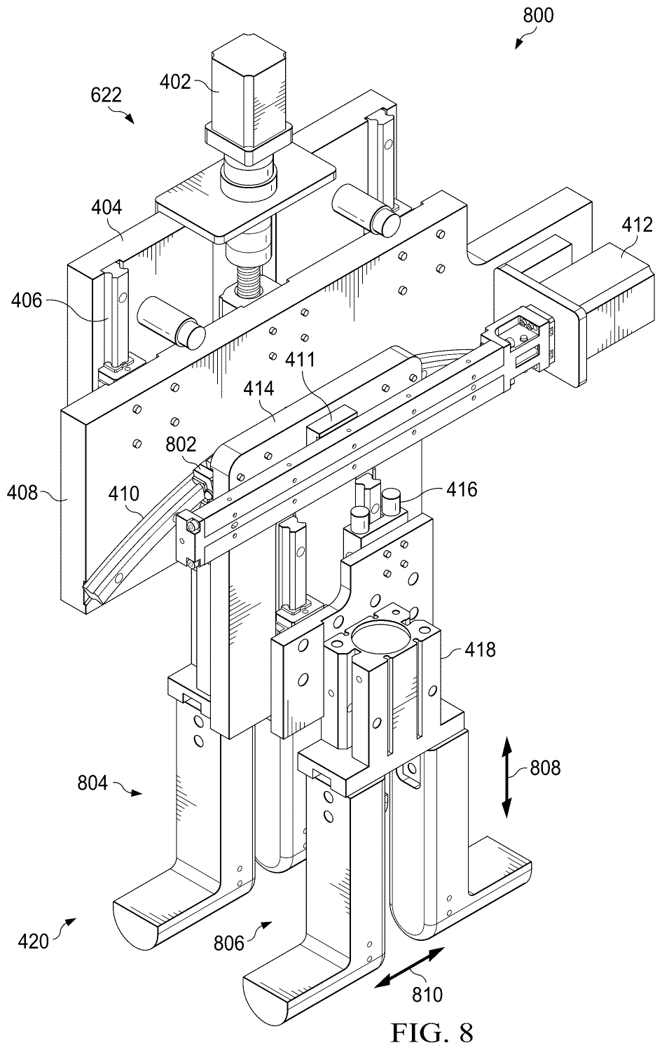

Turning now to FIG. 8, an illustration of an isometric view of a handling header in a third position is depicted in accordance with an illustrative embodiment. In view 800, handling header 401 is in neutral position 422. In view 800, cart fixtures 802 connecting carriage 414 to curved rail 410 are partially visible. In view 800, finger pair 804 and finger pair 806 of gripper 420 are visible.

In some illustrative examples, finger pair 804 is movable independently of finger pair 806. In some illustrative examples, finger pair 804 is movable in Z-direction 808 independently of finger pair 806. In these illustrative examples, an additional dimensional adjustment actuator (not visible) is provided to move finger pair 804 in Z-direction 808. Actuators 418 comprise a first actuator connected to finger pair 804 and a second actuator connected to finger pair 806. The first actuator is configured to move finger pair 804 to move finger pair 804 towards or away from each other in Y-direction 810. The second actuator is configured to move finger pair 806 towards or away from in each other in Y-direction 810. Actuators 418 are configured to open and close finger pair 804 and finger pair 806. In some illustrative examples, finger pair 804 is opened and closed in Y-direction 810 independently of finger pair 806. Finger pair 804 and finger pair 806 can be moved in Z-direction 808 and opened and closed in Y-direction 810 to grip a longitudinal component. In some illustrative examples, finger pair 804 and finger pair 806 can be moved in Z-direction 808 to twist a longitudinal component.

Although L-shaped opposing fingers are depicted in FIGS. 4-9 configured to lift a longitudinal component with a T cross-sectional shape, in other illustrative examples, grippers can have a different shape. In other illustrative examples, grippers of a handling system can be configured to lift a longitudinal component having one of a Z cross-sectional shape, a C cross-sectional shape, a L cross-sectional shape, or any other desirable shape. Although mechanical grippers are shown and described, in other non-depicted illustrative examples, grippers of a handling system can utilize pneumatic grippers to grip and lift a respective longitudinal component.

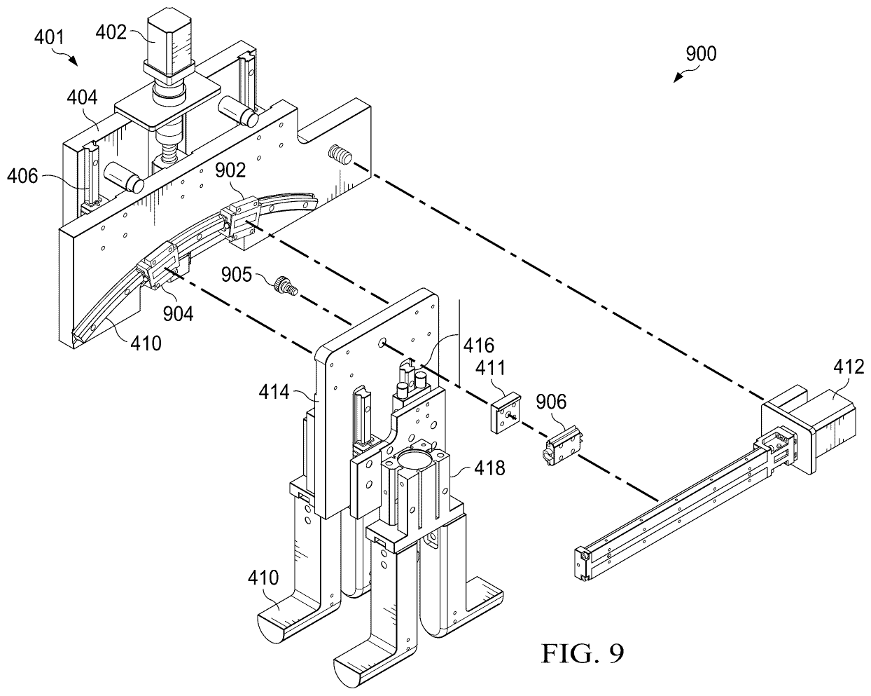

Turning now to FIG. 9, an illustration of an isometric exploded view of a handling header is depicted in accordance with an illustrative embodiment. In view 900 cart fixtures 802 connecting carriage 414 to curved rail 410 are visible. In this illustrative example, cart fixtures 802 comprise cart fixture 902 and cart fixture 904 configured to connect to carriage 414. Cart fixture 902 and cart fixture 904 allow movement of carriage 414 along curved rail 410. In view 900, pivoting motor pin 411 is exploded. Pivoting motor pin 411 comprises cart fixture 906 that travels along a track of twist actuator 412. Pin 905 connects carriage 414 to cart fixture 906 such that carriage 414 can rotate about pin 905 as carriage 414 moves along curved rail 410.

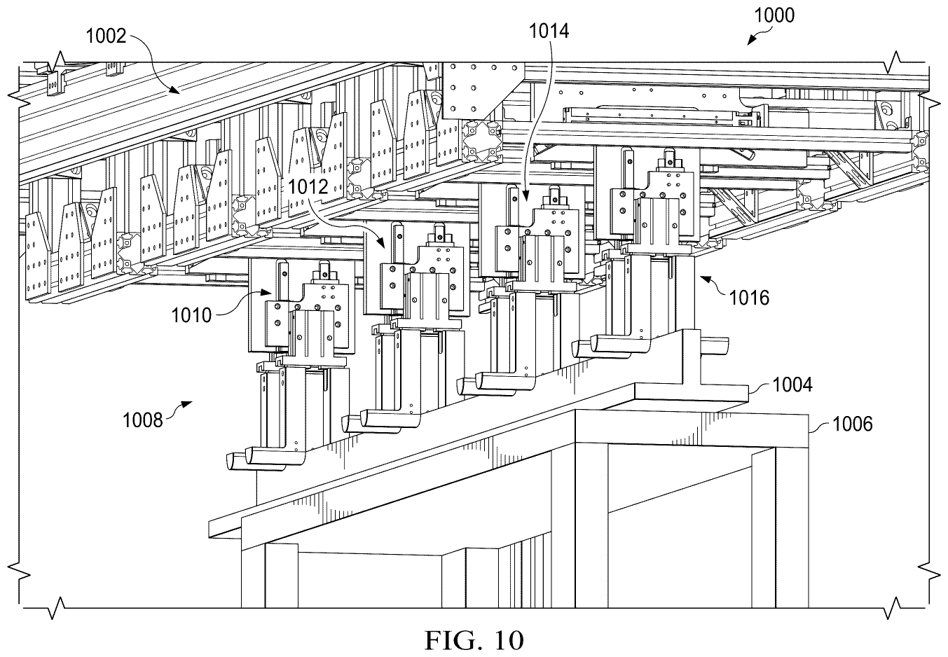

Turning now to FIG. 10, an illustration of an isometric bottom view of a handling system is depicted in accordance with an illustrative embodiment. View 1000 is a view of handling system 1002 being lowered into contact with longitudinal component 1004. Longitudinal component 1004 is resting on layup tool 1006. In view 1000 plurality of handling headers 1008 are being lowered into contact with longitudinal component 1004. In this illustrative example, handling header 1010, handling header 1012, handling header 1014, and handling header 1016 are being lowered such that a blade of longitudinal component 1004 is positioned between L-shaped contact components of respective grippers. After gripping longitudinal component 1004, plurality of handling headers 1008 will lift longitudinal component 1004. After lifting longitudinal component 1004, plurality of handling headers 1008 is used to impart a desired longitudinal conformation into longitudinal component 1004. In some illustrative examples, after gripping longitudinal component 1004, plurality of handling headers 1008 will simultaneously lift and then simultaneously form a twist into longitudinal component 1004.

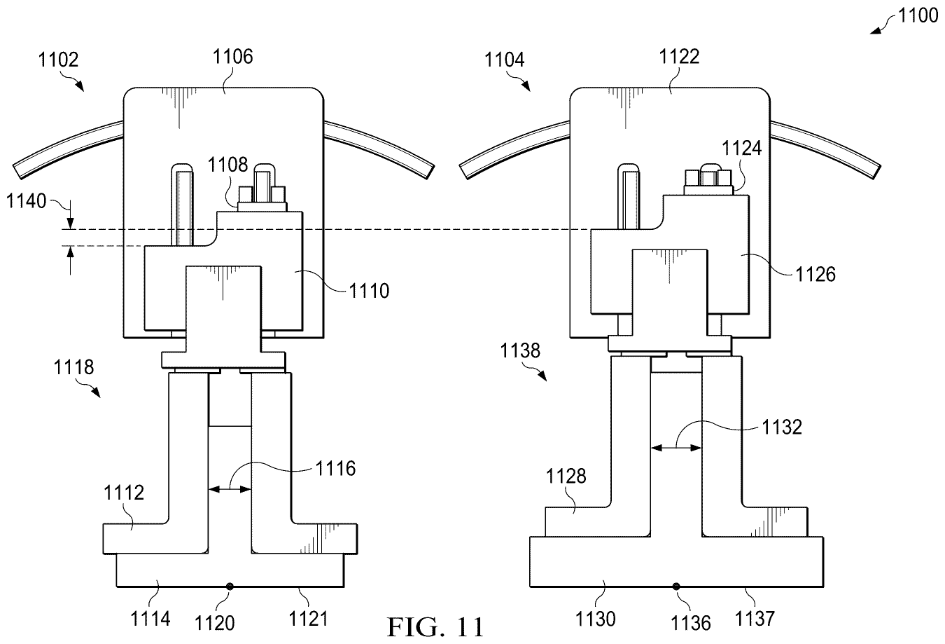

Turning now to FIG. 11, an illustration of a front view of handling headers gripping stringers of different thicknesses is depicted in accordance with an illustrative embodiment. View 1100 is a view of configurations of handling headers to place a rotational axis based on a thickness and size of the longitudinal component. In view 1100, cross-section 1130 of a longitudinal component is both taller and thicker than cross-section 1114 of a longitudinal component. In some illustrative examples, cross-section 1114 and cross-section 1130 are from a same longitudinal component. In these illustrative examples, the longitudinal component has a variable cross-section. A handling system of the illustrative examples can impart a desired longitudinal conformation into a longitudinal component with a varying cross-section. A handling system of the illustrative examples can place at least one of twist or skew into a longitudinal component with a varying cross-section. When a longitudinal component has a varying cross-section, the plurality of handling headers will have different alignments of the respective grippers prior to beginning forming, such as twisting.

In other illustrative examples, cross-section 1114 and cross-section 1130 are from different longitudinal components with constant cross-sections. In these illustrative examples, each handling header of a plurality of handling headers will have a same alignment to grip and lift a longitudinal component.

Alignment includes the space separating components of a respective gripper and a Z-position of the gripper within the handling header. View 1100 depicts differences in alignment for different sizes of longitudinal component cross-section. View 1100 only shows a portion of each handling header. In view 1100, a base and a body of each handling header is not depicted for ease of explanation.

Handling header 1102 includes carriage 1106, dimensional adjustment actuator 1108, actuator 1110, and gripper 1112. In this illustrative example, gripper 1112 has been positioned to grip a longitudinal component having cross-section 1114 and base 1121. In this illustrative example, gripper has gap 1116 to hold the longitudinal component with cross-section 1114. Actuator 1110 is utilized to open and close gripper 1112. Actuator 1110 can increase or decrease gap 1116 to grip the longitudinal component.

Handling header 1102 has alignment 1118 to position rotational axis 1120 on base 1121. Handling header 1102 is aligned to place rotational axis 1120 at a center point of base 1121. Dimensional adjustment actuator 1108 is used to position gripper 1112 relative to carriage 1106. Movement of gripper 1112 by dimensional adjustment actuator 1108 aligns rotational axis 1120.

Handling header 1104 includes carriage 1122, dimensional adjustment actuator 1124, actuator 1126, and gripper 1128. In this illustrative example, gripper 1128 has been positioned to grip a longitudinal component having cross-section 1130 and base 1137. In this illustrative example, gripper has gap 1132 to hold the longitudinal component with cross-section 1130. Actuator 1126 is utilized to open and close gripper 1128. Actuator 1126 can increase or decrease gap 1132 to grip the longitudinal component.

Handling header 1104 has alignment 1138 to position rotational axis 1136 on base 1137. Handling header 1104 is aligned to place rotational axis 1136 at a center point of base 1137. Dimensional adjustment actuator 1124 is used to position gripper 1128 relative to carriage 1122. Movement of gripper 1128 by dimensional adjustment actuator 1124 aligns rotational axis 1136.

In this illustrative example, gripper 1128 is positioned closer to a respective curved rail than gripper 1112. Difference 1140 in vertical positioning between gripper 1128 and gripper 1112 maintains a desired position of rotational axis 1136 taking into account the differences in thickness and height between cross-section 1130 and cross-section 1114.

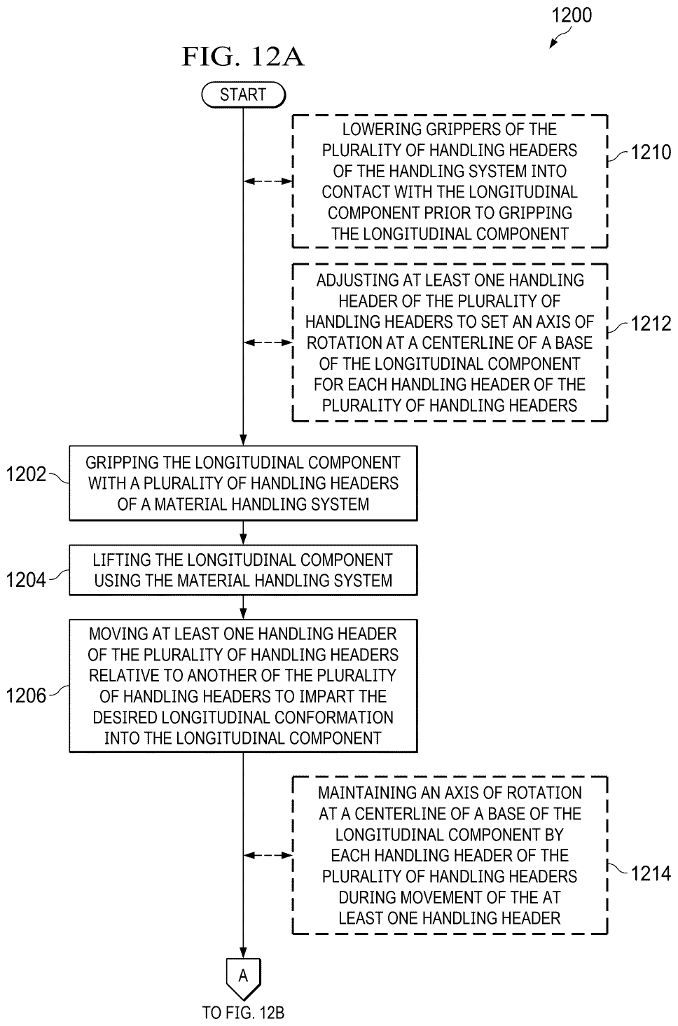

Turning now to FIGS. 12A and 12B, a flowchart of a method of imparting a desired longitudinal conformation into a longitudinal component in accordance with an illustrative embodiment. Method 1200 can be performed by handling system 202 to impart desired longitudinal conformation 203 into longitudinal component 204 of FIG. 2. Method 1200 can be performed by handling system 301 to impart a desired longitudinal conformation into longitudinal component 304 of FIG. 3. Method 1200 can be performed using handling header 401 of FIGS. 4-9. Method 1200 can be performed by handling system 1002 to impart a desired longitudinal conformation into longitudinal component 1004 of FIG. 10. Method 1200 can be performed by handling system 1002 to impart a twist into longitudinal component 1004 of FIG. 10. Method 1200 can be performed using handling header 1102 or handling header 1104 of FIG. 11.

Method 1200 grips the longitudinal component with a plurality of handling headers of a handling system (operation 1202). In some illustrative examples, the plurality of handling headers mechanically grip the longitudinal component. In some illustrative examples, the plurality of handling headers pneumatically grip the longitudinal component.

Method 1200 lifts the longitudinal component using the handling system (operation 1204). In some illustrative examples, the longitudinal component is lifted by moving the handling system upward. In some illustrative examples, the handling system can be moved upward by a gantry or a robotic arm. In some illustrative examples, the longitudinal component is lifted by moving each handling header of the plurality of handling headers independently. In some illustrative examples, each handling header lifts the longitudinal component using a respective lift actuator of the handling header.

Method 1200 further includes moving at least one handling header of the plurality of handling headers relative to another of the plurality of handling headers to impart the desired longitudinal conformation into the longitudinal component (operation 1206). Afterwards, method 1200 may terminate.

In some illustrative examples, method 1200 lowers grippers of the plurality of handling headers of the handling system into contact with the longitudinal component prior to gripping the longitudinal component (operation 1210). In some illustrative examples, the plurality of handling headers can be lowered by lowering an entirety of the handling system. In some illustrative examples, the plurality of handling headers is lowered by lowering a rigid frame of the handling system by a gantry or a robotic arm. In some illustrative examples, the plurality of handling headers is lowered by a respective lift actuator of each respective handling header of the plurality of handling headers.

In some illustrative examples, method 1200 adjusts at least one handling header of the plurality of handling headers to set an axis of rotation at a centerline of a base of the longitudinal component for each handling header of the plurality of handling headers (operation 1212). In some illustrative examples, method 1200 maintains an axis of rotation at a centerline of a base of the longitudinal component by each handling header of the plurality of handling headers during movement of the at least one handling header (operation 1214). In some illustrative examples, the axis of rotation is maintained at a centerline of a base through the movement of the handling header using a curved rail. In some illustrative examples, the axis of rotation is located at a centerline of a base by configuring the grippers of the plurality of handling headers based on a thickness and height of the longitudinal component. In some illustrative examples, the axis of rotation is located at a centerline of a base by moving grippers of the plurality of handling headers relative to other components of the plurality of handling headers.

In some illustrative examples, moving the at least one handling header comprises simultaneously starting movement of the plurality of handling headers and simultaneously stopping movement of the plurality of handling headers, and wherein simultaneously starting movement of the plurality of handling headers and simultaneously stopping movement of the plurality of handling headers distributes stresses throughout the longitudinal component (operation 1216). Simultaneous twist velocity control across all handling headers of the plurality of handling headers enables all handling headers to start and end twisting process simultaneously, for even stress distribution.

In some illustrative examples, moving the at least one handling header comprises cooperatively moving the plurality of handling headers to impart a twist into the longitudinal component (operation 1217).

In some illustrative examples, moving the at least one handling header of the handling system comprises moving a gripper of a respective handling header of the plurality of handling headers along a respective curved rail of the respective handling header (operation 1218). In some illustrative examples, movement along a respective curved rail imparts a twist into the longitudinal component while maintaining the axis of rotation in a desired location. In some illustrative examples, moving the at least one handling header of the handling system comprises rotating a gripper of a respective handling header of the plurality of handling headers one of clockwise or counterclockwise (operation 1220).

In some illustrative examples, method 1200 lowers, by the plurality of handling headers, the longitudinal component with the desired longitudinal conformation onto a tool (operation 1222). In some illustrative examples, method 1200 releases, by the plurality of handling headers, the longitudinal component with the desired longitudinal conformation on the tool (operation 1224). In these illustrative examples, the handling system is configured to handle and form the longitudinal component. As a result, the handling system can combine the positioning and twisting steps for manufacturing the longitudinal component into a single step.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1210 through operation 1224 may be optional.

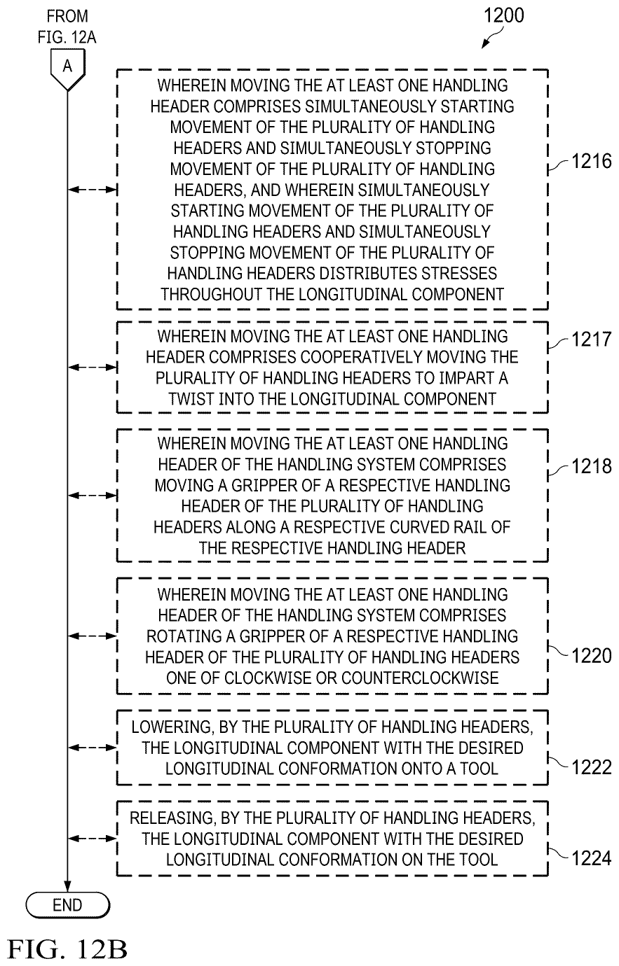

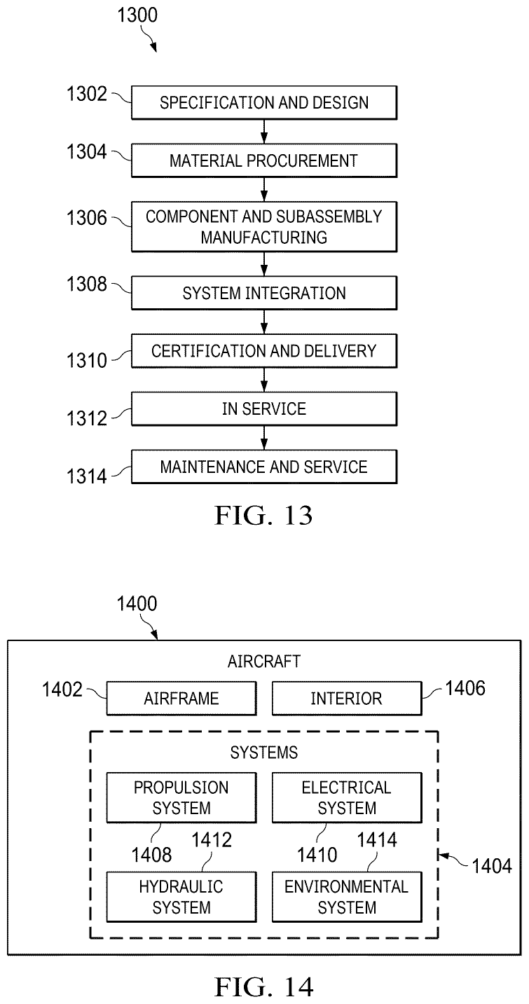

Illustrative embodiments of the present disclosure may be described in the context of aircraft manufacturing and service method 1300 as shown in FIG. 13 and aircraft 1400 as shown in FIG. 14. Turning first to FIG. 13, an illustration of an aircraft manufacturing and service method in a form of a block diagram is depicted in accordance with an illustrative embodiment. During pre-production, aircraft manufacturing and service method 1300 may include specification and design 1302 of aircraft 1400 in FIG. 14 and material procurement 1304.

During production, component and subassembly manufacturing 1306 and system integration 1308 of aircraft 1400 takes place. Thereafter, aircraft 1400 may go through certification and delivery 1310 in order to be placed in service 1312. While in service 1312 by a customer, aircraft 1400 is scheduled for routine maintenance and service 1314, which may include modification, reconfiguration, refurbishment, or other maintenance and service.

Each of the processes of aircraft manufacturing and service method 1300 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 14, an illustration of an aircraft in a form of a block diagram is depicted in which an illustrative embodiment may be implemented. In this example, aircraft 1400 is produced by aircraft manufacturing and service method 1300 of FIG. 13 and may include airframe 1402 with plurality of systems 1404 and interior 1406. Examples of systems 1404 include one or more of propulsion system 1408, electrical system 1410, hydraulic system 1412, and environmental system 1414. Any number of other systems may be included.

Apparatuses and methods embodied herein may be employed during at least one of the stages of aircraft manufacturing and service method 1300. One or more illustrative embodiments may be manufactured or used during at least one of component and subassembly manufacturing 1306, system integration 1308, in service 1312, or maintenance and service 1314 of FIG. 13.

The illustrative examples provide an automated mechanical header design to enable imparting at least one of a twist or skew while maintaining a correct center of rotation and stringer natural path. The illustrative examples provide controls for simultaneous coordinated movement of headers to ensure twist starts and ends at the same time for each handling header, allowing a more even spread of stresses throughout the stringer than manual sequential application of twist at each discrete location.

The illustrative examples are automated and apply twist simultaneously at multiple points down the length of the stringer, spreading out the stresses in the material during twist. The illustrative examples can manufacture a longitudinal component with a twist with fewer inconsistencies, such as wrinkling, when compared to manual processes. The illustrative examples, can manufacture a longitudinal component with a twist with a lower manufacturing time.

The illustrative examples combine the process to apply twist with the stringer handling system, thereby reducing flow time by enabling simultaneous handling and twist. The illustrative examples reduce manufacturing time for longitudinal components with twists or skew.

The handling headers of the illustrative examples can be attached to a local gantry, industrial robot arms, or other locomotion device. The handling headers of the illustrative examples can be moved without utilizing cranes, which can be undesirably time consuming.

The illustrative examples provide a mechanical design of header with a pivoting motor pin sliding on curved rail for twist around contoured axis of rotation at stringer base centerline. Actuation in skew (y-axis) achieves a stringer natural path. Macro actuation in z-axis matches large scale stringer contour at each header. Micro compliance in z-axis locally matches material gage thickness. A contact sensor can be used to detect stringer contact. Simultaneous twist velocity control across all headers can be used to ensure all headers start and end twisting process simultaneously, for even stress distribution. Headers can be mounted on local gantry or robotic arms. Indexing can be performed using a camera, profilometer, or other metrology. Indexing can be performed using a camera or a profilometer to detect a corner and edge of stringer. Data is fed back to header controllers to index gripping locations.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A handling system for imparting a desired longitudinal conformation into a longitudinal component comprising:
a rigid frame; and
a plurality of handling headers movably connected to the rigid frame, the plurality of handling headers configured to:
grip a longitudinal component;
lift the longitudinal component; and
cooperatively move to impart the desired longitudinal conformation into the longitudinal component.

2. The handling system of claim 1, wherein the rigid frame comprises a plurality of cross-beams, and wherein the plurality of handling headers is configured to move along the plurality of cross-beams.

3. The handling system of claim 1, wherein each handling header is configured to maintain an axis of rotation at a centerline of a base of the longitudinal component.

4. The handling system of claim 2, wherein each handling header comprises:
a base configured to traverse a cross-beam of the plurality of cross-beams of the rigid frame;
a body movably connected to the base by a lift actuator;
a curved rail mounted on the body; and
a gripper movably connected to the curved rail and configured to contact and lift the longitudinal component.

5. The handling system of claim 4, wherein each handling header further comprises:
a carriage movably connected to the curved rail, wherein the gripper is connected to the carriage by a dimensional adjustment actuator.

6. The handling system of claim 1, further comprising:
a movement system connected to the rigid frame and configured to allow movement of the rigid frame across a manufacturing floor.

7. The handling system of claim 1, further comprising:
a number of sensors configured to determine a distance of the plurality of handling headers from the longitudinal component, the number of sensors selected from a contact sensor or a proximity sensor.

8. The handling system of claim 1, further comprising:
an indexing system comprising at least one a camera or a profilometer and configured to provide indexing data for the plurality of handling headers relative to the longitudinal component.

9. The handling system of claim 1 further comprising:
a gantry connection configured to attach the handling system to a gantry.

10. The handling system of claim 1 further comprising:
a connector configured to attach the handling system to an industrial robot arm.

11. A handling system for imparting a desired longitudinal conformation into a longitudinal component comprising:
a rigid frame comprises a plurality of cross-beams; and
a plurality of handling headers movably connected to the plurality of cross-beams, the plurality of handling headers configured to maintain an axis of rotation at a centerline of a base of the longitudinal component, each handling header of the plurality of handling headers comprising:
a base configured to traverse a cross-beam of the plurality of cross-beams of the rigid frame;
a body movably connected to the base by a lift actuator;
a curved rail mounted on the body; and
a gripper movably connected to the curved rail and configured to contact and lift the longitudinal component.

12. The handling system of claim 11, wherein each handling header further comprises:
a carriage movably connected to the curved rail, wherein the gripper is connected to the carriage by a dimensional adjustment actuator.

13. The handling system of claim 12, wherein the carriage is driven along the curved rail by a twist actuator, and wherein the twist actuator is connected to the carriage by a pivoting motor pin.

14. A method of imparting a desired longitudinal conformation into a longitudinal component comprising:
gripping the longitudinal component with a plurality of handling headers of a handling system;
lifting the longitudinal component using the handling system; and
moving at least one handling header of the plurality of handling headers relative to another of the plurality of handling headers to impart the desired longitudinal conformation into the longitudinal component.

15. The method of claim 14 further comprising:
lowering grippers of the plurality of handling headers of the handling system into contact with the longitudinal component prior to gripping the longitudinal component.

16. The method of claim 14 further comprising:
maintaining an axis of rotation at a centerline of a base of the longitudinal component by each handling header of the plurality of handling headers during movement of the at least one handling header.

17. The method of claim 14, wherein moving the at least one handling header comprises:
simultaneously starting movement of the plurality of handling headers and simultaneously stopping movement of the plurality of handling headers, and wherein simultaneously starting movement of the plurality of handling headers and simultaneously stopping movement of the plurality of handling headers distributes stresses throughout the longitudinal component.

18. The method of claim 14, wherein moving the at least one handling header comprises cooperatively moving the plurality of handling headers to impart a twist into the longitudinal component.

19. The method of claim 14, wherein moving the at least one handling header of the handling system comprises moving a gripper of a respective handling header of the plurality of handling headers along a respective curved rail of the respective handling header.

20. The method of claim 14, wherein moving the at least one handling header of the handling system comprises rotating a gripper of a respective handling header of the plurality of handling headers one of clockwise or counterclockwise.

21. The method of claim 14 further comprising:
lowering, by the plurality of handling headers, the longitudinal component with the desired longitudinal conformation onto a tool; and
releasing, by the plurality of handling headers, the longitudinal component with the desired longitudinal conformation on the tool.

22. The method of claim 14 further comprising:
adjusting at least one handling header of the plurality of handling headers to set an axis of rotation at a centerline of a base of the longitudinal component for each handling header of the plurality of handling headers.
